(19) United States
(12) Patent Application Publication
(10) Pub. No.: US 2007/0097831 A1
(43) Pub. Date: May 3, 2007

(54) Apparatus and method for controlling a recording light signal

(76) Inventors: Soo-yong Kim, Suwon-si (KR); Bong-ryeol Lee, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/529,471

(22) Filed: Sep. 29, 2006

(30) Foreign Application Priority Data
Oct. 28, 2005 (KR) 10-2005-0102503

(51) Int. Cl. G11B 7/0045

(52) U.S. Cl. 369/59.11

(57) ABSTRACT

A method and apparatus for controlling a light source for use with an optical disc, the light source being driven with a write signal including a multi-pulse train, includes detecting an output of the light source and for outputting a monitored voltage and a compensator for compensating a multi-pulse voltage corresponding to the multi-pulse train in accordance with the monitored voltage. The compensation may adjust the multi-pulse train in accordance with a comparison of a reference voltage and the monitored voltage, a number of times the monitored voltage crosses the reference voltage or a relationship between a stable portion of the writing signal and the multi-pulse train determined during initialization.

### BACKGROUND OF THE INVENTION

1. Field of the Invention

The present invention is related to an apparatus and method for controlling a recording light signal. More particularly, the present invention is related to an apparatus and method for controlling the recording light signal in accordance with changes in operational characteristics of the recording light signal.

2. Description of Related Art

Light sources used in optical recording and reproducing apparatuses, e.g., blu ray disc (BD), compact disc (CD), digital versatile disc (DVD), high definition (HD)-DVD, have operational characteristics that may change due to a number of factors, e.g., temperature, age and humidity. Only if the optical recording and reproducing apparatus has a stable light source can data on an optical disk be faithfully recorded and reproduced.

In addressing this problem, optimum power control (OPC) has been used. For OPC to be realized, disc manufacturers store suitable recording power values in lead-in areas of recordable discs. An optical disc recording apparatus tests the suitable recording power values to obtain an optimum or target power when a disc is loaded in the optical disc recording apparatus.

FIG. 1 illustrates a block diagram of an optical recording and reading apparatus including a conventional automatic light power controller (ALPC) 5 and a light source 1. Here, the light source 1 controlled by the ALPC 5 is illustrated as a laser diode (LD) 2 whose output is monitored by a detector 3. The ALPC 5 may include a reference voltage generator 51, a comparator 52, a target power operation circuit 53, an LD driver 54 and an LD output monitor 55.

The reference voltage generator 51 outputs a reference voltage Vr corresponding to the target power obtained by the OPC process. The LD output monitor 55 receives the output from the detector 3 and outputs a corresponding monitored voltage Vm. The comparator 52 compares the reference voltage Vr with the monitored voltage Vm and outputs the difference. The target power operation circuit 53 adds or subtracts the difference to or from the previous recording signal to compensate for the previous recording signal, and outputs the compensated signal as the write signal WS. The LD driver 54 converts the voltage values of the compensated recording signal into current values and drives the LD 2 with the compensated recording signal. Thus, the ALPC 5 automatically compensates for any changes in the output of the LD 2, and, thus, of the recording light signal or write pulse WP.

FIGS. 2A-2C illustrate waveforms used in the operation of an optical recording and reading apparatus, particularly for a rewritable optical medium. Referring to FIG. 2A, the write signal may include a multi-pulse train, during which a single mark is created on the optical medium. The multi-pulse train may include a plurality of pulses having a peak power and a base power. Multi-pulse trains may be separated by an erase stage, during which an erase power is applied.

Referring to FIG. 2B, the output of a detector in response to the write signal WS is analog, and does not exactly follow the waveform of the write signal. As shown in FIG. 2C, a sample pulse SP of a sample and hold signal may only sample during stable erase operations.

Thus, the conventional ALPC 5 only compensates the erase power, i.e., it does not compensate during recording. Moreover, even if the sampling frequency is increased, the conventional ALPC cannot obtain the exact value of the peak or base powers. Thus, the recording quality may be poor.

### SUMMARY OF THE INVENTION

The present invention is therefore directed to a method and apparatus for controlling a recording light signal, which substantially overcome one or more of the problems due to the limitations and disadvantages of the related art.

It is therefore a feature of an embodiment of the present invention to provide a method and apparatus that readily compensate for changes in voltages used during recording, e.g., voltages corresponding to the peak and base powers, due to changes in operational characteristics of a light source.

It is therefore another feature of an embodiment of the present invention to provide a method and apparatus that compensate for changes in voltages used during recording, e.g., voltages corresponding to the peak and base powers, due to changes in operational characteristics of a light source in accordance with reference voltages.

It is therefore yet another feature of an embodiment of the present invention to provide a method and apparatus that compensate for changes in voltages used during recording, e.g., voltages corresponding to the peak and base powers, due to changes in operational characteristics of a light source in accordance with a number of times a monitored voltage crosses reference voltages.

It is therefore still another feature of an embodiment of the present invention to provide a method and apparatus that compensate for changes in voltages used during recording, e.g., voltages corresponding to the peak and base powers, due to changes in operational characteristics of a light source in accordance with relationships between the peak and base voltages and stable portions of the writing signal.

At least one of the above and other features and advantages of the present invention may be provided by a method of controlling a light source for use with an optical disc, the light source being driven with a signal including a multi-pulse train, the method including detecting an output of the light source and outputting a monitored voltage, and compensating for at least two voltages corresponding to the multi-pulse train in accordance with the monitored voltage.

The compensating may include comparing a reference voltage with the monitored voltage. The compensating may include determining a recording signal by adjusting a previous recording signal with a predetermined value in accordance with a result of the comparing.

The compensating may include counting a number of times the monitored voltage crosses the reference voltage in accordance with the comparing, and determining a recording signal by adjusting a previous recording signal with a predetermined value in accordance with the number of times. The adjusting may include adjusting the previous recording signal with the predetermined value in a first manner when the number of times is equal to or greater than a maximum threshold, and adjusting the previous recording signal with the predetermined value in a second manner when the number of times is equal to or less than a minimum threshold. When the number of times is between the minimum and maximum thresholds, the previous recording signal may be used.

The reference voltage includes a range of reference voltages. The compensating may include compensating for a peak voltage of the multi-pulse voltage and compensating for a base voltage of the multi-pulse voltage.

The method may include, during initialization of the optical disc, determining a relationship between a voltage of a stable portion of the writing signal and the multi-pulse train, wherein compensating includes adjusting a compensated voltage for the stable portion in accordance with the relationship. The stable portion may be an erase stage.

At least one of the above and other features and advantages of the present invention may be provided by an apparatus for controlling a light source for use with an optical disc, the light source being driven with a write signal including a multi-pulse train, the apparatus including a detector for detecting an output of the light source and for outputting a monitored voltage, and a compensator for compensating a multi-pulse voltage corresponding to the multi-pulse train in accordance with the monitored voltage.

The compensator may compare a reference voltage with the monitored voltage and generates a compared result. The compensator may generate a recording signal based on a previous recording signal adjusted by a predetermined value in accordance with the compared result.

The compensator may count a number of times the monitored voltage crosses the reference voltage in accordance with the compared result and may generate a recording signal based on a previous recording signal adjusted by a predetermined value in accordance with the number of times. The compensator may adjust the previous recording signal with the predetermined value in a first manner when the number of times is equal to or greater than a maximum threshold, and may adjust the previous recording signal with the predetermined value in a second manner when the number of times is equal to or less than a minimum threshold. When the number of times is between the minimum and maximum thresholds, the previous recording signal may be used as the recording signal.

The reference voltage includes a range of reference voltages.

The compensator may include a peak compensator for compensating for a peak voltage of the multi-pulse voltage and a base compensator for compensating for a base voltage of the multi-pulse voltage. The peak and base compensator each may include a corresponding bandpass filter.

The compensator may adjust a compensated voltage for a stable portion in accordance with a relationship between a voltage of the stable portion of the writing signal and the multi-pulse train determined during initialization of the optical disc.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of a conventional automatic light power controller of an optical recording and reading apparatus;

FIGS. 2A-2C illustrate waveforms used in the operation of the optical recording and reading apparatus of FIG. 1;

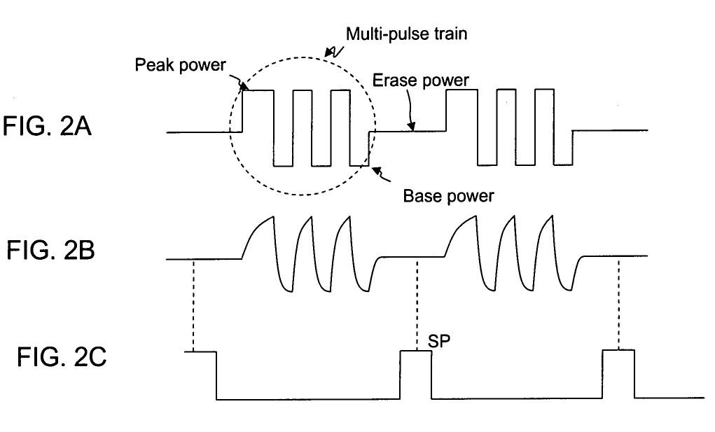

FIG. 3 illustrates a block diagram of an automatic light power controller in accordance with an embodiment of the present invention;

FIG. 4 illustrates a block diagram of a peak power automatic light power controller in accordance with an embodiment of the present invention;

FIG. 5 illustrates a block diagram of a base power automatic light power controller in accordance with an embodiment of the present invention;

FIGS. 6A-6D illustrate multi-pulse portions of the waveforms relative to the peak and base powers; and

FIG. 7 illustrates a block diagram of an automatic light power controller in accordance with another embodiment of the present invention.

### DETAILED DESCRIPTION OF THE INVENTION

Korean Patent Application No. 10-2005-0102503, filed Oct. 28, 2005, in the Korean Intellectual Property Office, and entitled: “Apparatus and Method for Controlling a Recording Light Signal,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

In accordance with embodiments of the present inventions, all stages of recording/reproducing may be compensated for changes in operational characteristics of a light source, even when a particular waveform within the write signal may not be directly monitored.

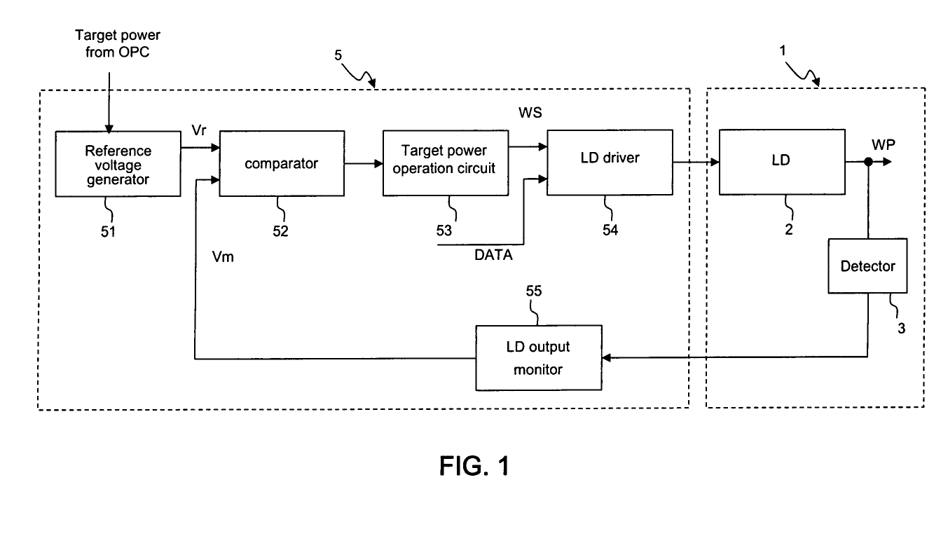

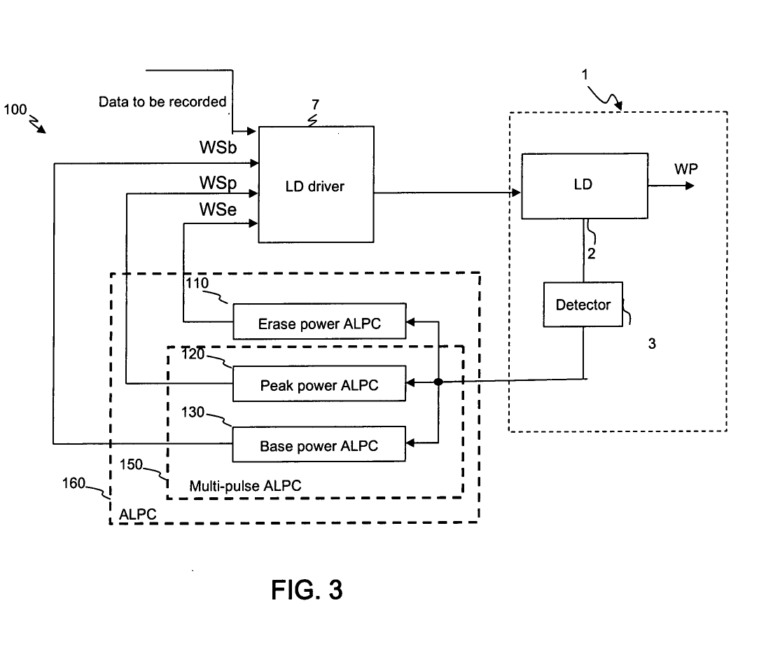

In accordance with an embodiment of the present invention shown in FIG. 3, an optical apparatus 100 for outputting a recording/reproducing signal for use with an optical disk may include an ALPC 160, which may include a multi-pulse ALPC 150 and an erase power ALPC 110. The multi-pulse ALPC may include a peak power ALPC 120 and a base power ALPC 130. Each ALPC may include an appropriate bandpass filter. The remaining elements, i.e., the LD driver 7 and the light source 1, may be the same as in FIG. 1.

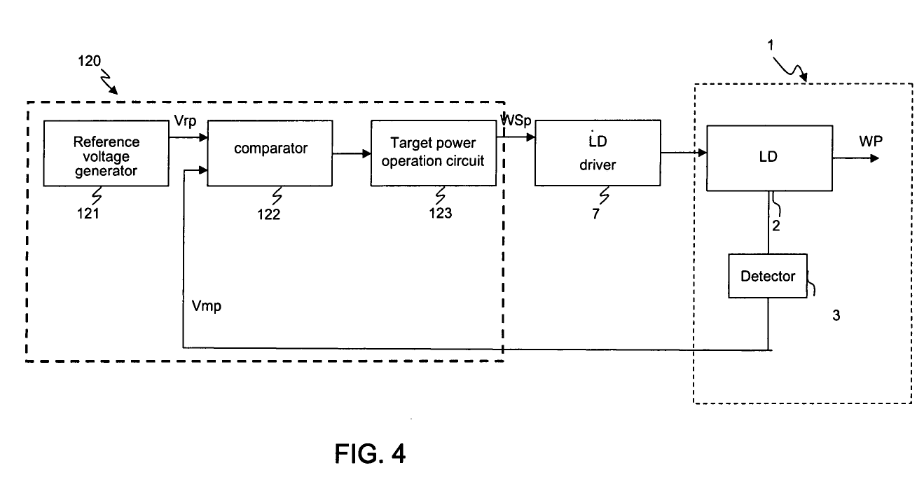

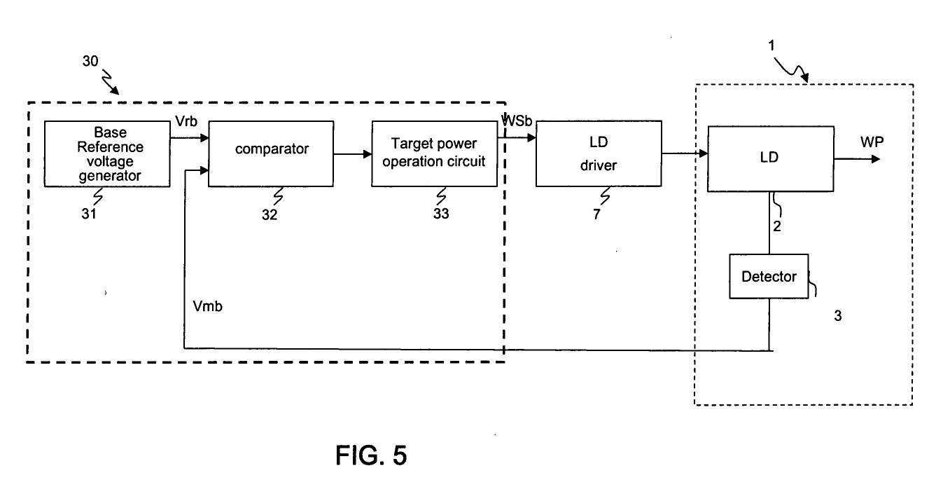

The erase power ALPC 110 may output an erase write signal WSe for use during the erase stage and the multi-pulse ALPC 160 may output write a peak write signal WSp and a base write signal WSb for use during the recording stage. Since an erase power can be directly measured, the erase power ALPC 110 may operate in the same manner as the ALPC 5 of FIG. 1. An embodiment of the operation of the peak power ALPC 120 and the base power ALPC 130 will be described below with reference to FIGS. 4-5.

As shown in FIG. 4, an embodiment of the peak power ALPC 120 may include a peak reference voltage generator 121, a comparator 122 and a target operation circuit 123. The peak reference voltage generator 121 may output a reference peak voltage Vrp, determined during OPC, to the comparator 122. When the monitored voltage Vm exceeds an allowable range for the erase stage, the monitored voltage Vm may be determined to be a monitored peak voltage Vmp. The monitored peak voltage Vmp may be compared to the reference peak voltage Vrp.

If the reference peak voltage Vrp exceeds the monitored peak voltage Vmp, the comparator 122 may output no signal or a “0”. In response, the target power operation circuit 123 may generate a peak write signal WSp by adjusting the previous peak write signal in accordance with a predetermined value PV, e.g., adding the predetermined value PV to the previous peak write signal.

If the monitored peak voltage Vmp exceeds the reference peak voltage Vrp, the comparator 122 may output an up pulse or a “1”, indicating that the monitored voltage has crossed over the reference peak voltage Vrp. In response, the target power operation circuit 123 may generate the peak write signal WSp by adjusting the previous peak write signal in accordance with a predetermined value PV, e.g., subtracting the predetermined value PV from the previous peak write signal, to be output as. The predetermined value PV may be determined experimentally.

As shown in FIG. 5, an embodiment of the peak power ALPC 130 may include a base reference voltage generator 131, a comparator 132 and a target operational circuit 133. The reference voltage generator 131 may output a reference base voltage Vrb, determined during OPC, to the comparator 132. When the monitored voltage Vm falls below an allowable range for the erase stage, the monitored voltage Vm may be determined to be a monitored base voltage Vmb. The monitored base voltage Vmb may be compared to the reference base voltage Vrb.

If the reference base voltage Vrb is less than the monitored base voltage Vmb, the comparator 132 may output no signal or a “0”. In response, the target power operation circuit 133 may generate a base write signal WSb by adjusting the previous base write signal in accordance with the predetermined value PV, e.g., subtracting a predetermined value PV from the previous base write signal.

If the monitored peak voltage Vmp is equal to the reference peak voltage Vrp, the target power operation circuit 123 may output previous peak write signal as the peak write signal WSp.

If the monitored base voltage Vmb is less than the reference base voltage Vrb, the comparator 132 may output a down pulse or a “1”, indicating that the monitored voltage has crossed the reference base voltage. Upon receiving the down pulse, the target power operation circuit 133 may generate the base write signal WSb by adjusting the previous base write signal in accordance with a predetermined value PV, e.g., adding the predetermined value PV to the previous base write signal.

If the monitored base voltage Vmb is equal to the reference base voltage Vrb, the target power operation circuit 133 may output previous base write signal as the base write signal WSb.

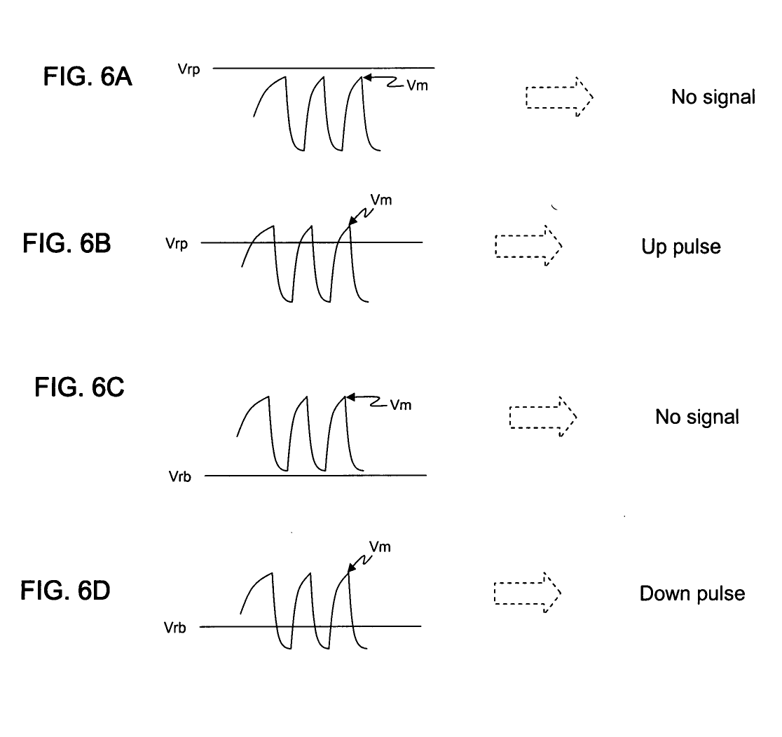

The adjusting to be performed on the write signals during the multi-pulse train is illustrated in FIGS. 6A-6D. As shown in FIG. 6A, if the monitored peak voltage Vmp does not exceed the peak reference voltage Vrp, no signal may be output to the target power operation circuit 123. As shown in FIG. 6B, if the monitored peak voltage Vmp exceeds the peak reference voltage Vrp, the up pulse may be output to the target power operation circuit 123.

As shown in FIG. 6C, if the monitored base voltage Vmb is not less than the base reference voltage Vrb, no signal may be output to the target power operation circuit 133. As shown in FIG. 6D, if the monitored base voltage Vmb is less than the base reference voltage Vrb, the down pulse may be output to the target power operation circuit 133.

The above discussion has assumed that the monitored peak and base voltages are uniform across the multi-pulse train, i.e., each peak and base has the same magnitude. However, in practice, there may be variation within the multi-pulse train itself. Therefore, the target power operation circuit 123, 133 may include a counter that counts a number of times a threshold is exceeded in the multi-pulse train.

For example, in the peak power ALPC 20, the target power operation circuit 123 may include a counter that counts a number of times a monitored peak voltage Vmp exceeds the reference peak voltage Vrp. If, at the end of the multi-pulse train, the counter has a value equal to or less than a minimum count value, e.g., zero, the target power operation circuit 123 may output a peak write signal WSp in accordance with the previous peak write signal plus the predetermined value PV. If, at the end of the multi-pulse train, the counter has a value equal to or greater than a maximum count value, e.g., one hundred, the target power operation circuit 123 may output a peak write signal WSp in accordance with the previous peak write signal minus the predetermined value PV. Otherwise, the target power operation circuit 123 may output the previous write signal as a peak write signal WSp.

For example, in the base power ALPC 30, the target power operation circuit 133 may include a counter that counts a number of times a monitored base voltage Vmb is below the reference base voltage Vrb. If, at the end of the multi-pulse train, the counter has a value equal to or less than a minimum count value, e.g., zero, the target power operation circuit 133 may output a base write signal WSb in accordance with the previous base write signal minus the predetermined value PV. If, at the end of the multi-pulse train, the counter has a value equal to or greater than a maximum count value, e.g., one hundred, the target power operation circuit 133 may output a base write signal WSb in accordance with previous base write signal plus the predetermined value PV. Otherwise, the target power operation circuit 133 may output the previous base write signal as a base write signal WSb.

The minimum and maximum count values may be determined experimentally.

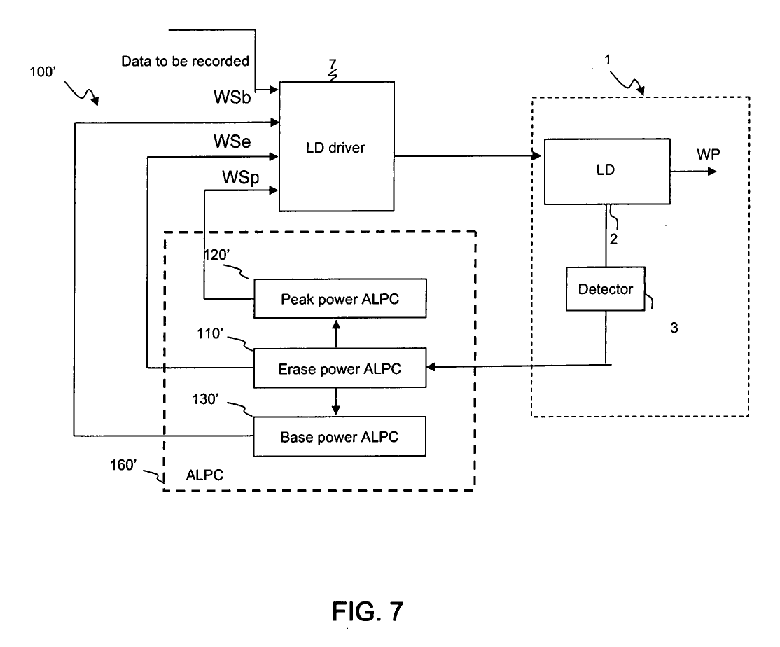

In accordance with of another embodiment of the present invention shown in FIG. 7, an optical apparatus 100′ for outputting a recording/ reproducing signal for use with an optical disk may include an ALPC 160′, which may include an erase power ALPC 110′, a peak power ALPC 120′ and a base power ALPC 130′. The remaining elements, i.e., the LD driver 7 and the light source 1, may be the same in FIG. 3.

As shown in FIG. 7, the erase power is first compensated by the erase power ALPC 110′. The compensated erase write signal WSe is then output to the LD driver, the peak power ALPC 120′ and the base power ALPC 130′. Then, the peak power ALPC 120′ and the base power ALPC 130′ may compensate the peak power and base power, respectively, in accordance with the compensated erase power.

In this embodiment, the OPC process may obtain the erase power, the peak power and the base power, the voltages corresponding thereto and the following relationships: α=peak voltage/erase voltage and β=base voltage/erase voltage. The ALPC 120′ may store a and the ALPC130′ may store. Then, during operation, the peak power ALPC 120′ may output a compensated peak voltage in accordance with the product of a and the compensated erase voltage, while the base power ALPC 130′, may output a compensated base voltage in accordance with the product of β and the compensated erase voltage.

Thus, all stages of recording/reproducing may be compensated for changes in a light source, even when a particular waveform within the write signal may not be directly monitored.

Exemplary embodiments of the present invention have been disclosed herein, and although specific terms are employed, they are used and are to be interpreted in a generic and descriptive sense only and not for purpose of limitation. While embodiments of the present invention have been described relative to a hardware implementation, the processing of present invention may be implemented in software, e.g., by an article of manufacture having a machine-accessible medium including data that, when accessed by a machine, cause the machine to determine a compensation voltage for the multi-pulse train voltages. Accordingly, it will be understood by those of ordinary skill in the art that various changes in form and details may be made without departing from the spirit and scope of the present invention as set forth in the following claims.

What is claimed is:

1. A method of controlling a light source for use with an optical disc, the light source being driven with a signal including a multi-pulse train, the method comprising:
detecting an output of the light source and outputting a monitored voltage; and
compensating for at least two voltages corresponding to the multi-pulse train in accordance with the monitored voltage.

2. The method as claimed in claim 1, wherein compensating comprises comparing a reference voltage with the monitored voltage.

3. The method as claimed in claim 2, wherein compensating comprises determining a recording signal by adjusting a previous recording signal with a predetermined value in accordance with a result of the comparing.

4. The method as claimed in claim 3, wherein compensating comprises:
counting a number of times the monitored voltage crosses the reference voltage in accordance with the comparing; and
determining a recording signal by adjusting a previous recording signal with a predetermined value in accordance with the number of times.

5. The method as claimed in claim 4, wherein adjusting comprises:
adjusting the previous recording signal with the predetermined value in a first manner when the number of times is equal to or greater than a maximum threshold; and
adjusting the previous recording signal with the predetermined value in a second manner when the number of times is equal to or less than a minimum threshold.

6. The method as claimed in claim 5, further comprising, when the number of times is between the minimum and maximum thresholds, using the previous recording signal.

7. The method as claimed in claim 2, wherein the reference voltage includes a range of reference voltages.

8. The method as claimed in claim 1, wherein compensating includes compensating for a peak voltage of the multi-pulse voltage and compensating for a base voltage of the multi-pulse voltage.

9. The method as claimed in claim 1, further comprising, during initialization of the optical disc, determining a relationship between a voltage of a stable portion of the writing signal and the multi-pulse train, wherein compensating includes adjusting a compensated voltage for the stable portion in accordance with the relationship.

10. The method as claimed in claim 9, wherein the stable portion is an erase stage.

11. An apparatus for controlling a light source for use with an optical disc, the light source being driven with a write signal including a multi- pulse train, the apparatus comprising:
a detector for detecting an output of the light source and for outputting a monitored voltage; and
a compensator for compensating a multi-pulse voltage corresponding to the multi-pulse train in accordance with the monitored voltage.

12. The apparatus as claimed in claim 11, wherein the compensator compares a reference voltage with the monitored voltage and generates a compared result.

13. The apparatus as claimed in claim 12, wherein the compensator generates a recording signal based on a previous recording signal adjusted by a predetermined value in accordance with the compared result.

14. The apparatus as claimed in claim 12, wherein the compensator:
counts a number of times the monitored voltage crosses the reference voltage in accordance with the compared result; and
generates a recording signal based on a previous recording signal adjusted by a predetermined value in accordance with the number of times.

15. The apparatus as claimed in claim 14, wherein the compensator:
adjusts the previous recording signal with the predetermined value in a first manner when the number of times is equal to or greater than a maximum threshold, and
adjusts the previous recording signal with the predetermined value in a second manner when the number of times is equal to or less than a minimum threshold.

16. The apparatus as claimed in claim 15, further comprising, when the number of times is between the minimum and maximum thresholds, using the previous recording signal.

17. The apparatus as claimed in claim 12, wherein the reference voltage includes a range of reference voltages.

18. The apparatus as claimed in claim 11, wherein the compensator includes a peak compensator for compensating for a peak voltage of the multi-pulse voltage and a base compensator for compensating for a base voltage of the multi-pulse voltage.

19. The apparatus as claimed in claim 18, wherein the peak and base compensator each include a corresponding bandpass filter.

20. The apparatus as claimed in claim 10, wherein the compensator adjusts a compensated voltage for a stable portion in accordance with a relationship between a voltage of the stable portion of the writing signal and the multi-pulse train determined during initialization of the optical disc.
